(19) United States
(12) Patent Application Publication
(10) Pub. No.: US 2023/0343244 A1
(43) Pub. Date: Oct. 26, 2023

(54) TRAINING DEVICE

(71) Applicant: VIRTUALISURG, Neuilly-sur-Seine (FR)

(72) Inventors: Ninon CANDALH-TOUTA, Neuilly-sur-Seine (FR); Nicolas MIGNAN, Neuilly-sur-Seine (FR); Cécile MULLER, Neuilly-sur-Seine (FR); David REVERSAT, Neuilly-sur-Seine (FR)

(73) Assignee: VIRTUALISURG, Neuilly-sur-Seine (FR)

(21) Appl. No.: 17/792,514

(22) PCT Filed: Jan. 13, 2021
(86) PCT No.: PCT/EP2021/050591

§ 371 Date: Jul. 13, 2022

(30) Foreign Application Priority Data
Jan. 13, 2020 (FR) FR2000256

(51) Int. Cl. G09B 23/34

(52) U.S. Cl. CPC G09B 23/34

(57) ABSTRACT

A training device for scientific or medical manipulation of a scientific or medical object, which includes at least one anatomical part and an envelope of said anatomical part; the anatomical part being made from at least one image of the scientific or medical object, in at least one first material, each of the first materials being able to generate a specific haptic feedback; and the envelope being manufactured from the same image of said scientific or medical object, in at least one second material different from the first material, and generating at least one haptic feedback different from that of the first material, the envelope being able to cover all or part of the anatomical part; the manufacture of the anatomical part and of the envelope being carried out by additive manufacturing or 3D printing or by subtractive manufacturing or by moulding.

### FIELD OF THE INVENTION

The present invention is about educational and teaching tools, methods and materials. More particularly, the invention relates to a training device for scientific or medical manipulation, for scientists or medical personnel. Furthermore, the invention relates to a device for training in a surgical procedure, said device being then preferably intended for the training of surgeons.

### STATE OF THE ART

Training in scientific or medical handling is usually based on practical work on real life examples, and trainees often work, starting from their first training, with chemicals, biological or medical materials or scientific instruments, which may be valuable, in real-life situations, where inexperienced handling may pose a risk.

For example, most surgical training is currently carried out in real conditions, on a patient, through surgical companionship. Some training-on-training devices, accessible to only a small proportion of surgical interns, have a number of obvious limitations; to give an example, one of the known training devices, the pelvitrainer, is a simple box into which trocars and a camera are inserted, with the possibility of training in suturing, for example on inert materials such as foam. This type of training is very focused and limited. Other training is done on animals manipulation on animals presents major problems of ethics, cost and limited anatomical correlation with humans.

International patent application WO2019/092382, filed by the Applicant, discloses a surgical simulation system for training and education of surgeons. The device comprises an enclosure comprising: a first surface defining an operation interface for receiving at least one surgical tool, the remainder of the surface of the enclosure forming a base; an aperture arranged on said first surface; and a connecting interface held at the circumference of said aperture. The first surface has a portion movable with respect to the base, and the opening is arranged on said movable portion. This enclosure is particularly interesting because it allows for a variety of procedures to be performed, but it does not allow for a continuous haptic experience throughout a surgical procedure. For this reason, the Applicant has continued its research and made the present invention to present a training device that better reflects the reality of a surgical procedure.

In the prior art, there are a few devices that combine an anatomical part with a supposedly skin-like environment. For example, U.S. Pat. No. 10,002,546 presents a model for anatomical training comprising a transparent thermoplastic elastomer matrix in which a part of a spine is embedded; a synthetic spinal sheath runs through a part of the spine. The transparent thermoplastic elastomer matrix allows the path of a needle to be visualised as it penetrates. The spine and synthetic spinal sheath provide tactile feedback during needle penetration. This device is intended to prepare surgeons to perform spinal injections. It does not allow for training on different surgical procedures.

US patent application US 2018/0322807 describes a simulated model of the abdominal wall for performing laparoscopic surgical techniques. The model comprises a simulated portion of the abdominal wall captured between two elements of a support. The support is connectable to a surgical training device. When connected to a training device, the model provides a penetrable portion of abdominal tissue for access to an internal cavity of the training unit. The simulated abdominal wall comprises a plurality of layers including a skin layer, a posterior rectus sheath tissue layer, a simulated fat layer of low resilience polyurethane foam and at least two layers that provide distinct haptic feedback upon penetration of the simulated transverse fascia and muscle layers. The simulated abdominal wall comprises a simulated navel over several layers of simulated tissue. The system described in this paper is a generic system that is assumed to simulate any abdomen, and does not allow for surgical variability arising from different patient typologies.

Also known is WO 2017/059417 describing a surgical simulator for surgical training. The simulator comprises a frame defining an enclosure and a simulated tissue model located within the enclosure. The simulated tissue model is suitable for performing a number of surgical procedures including transanal excisions and transvaginal hysterectomies. The simulated tissue model includes an additional component interchangeably connected to the frame with fasteners configured to pass through openings in the frame, to suspend the simulated tissue model in the frame. The frame enclosure is increasingly narrowed laterally along the longitudinal axis to progressively increase the containment of the components of the simulated tissue model. Again, the simulator is generic and does not allow for learning the different situations that are generated by the diversity of patients and their profiles.

In view of the prior art, the Applicant, listening to scientists and surgeons, realised (1) that learning could not be complete if the model was not adapted to patients and different pathologies, (2) that providing a single model did not reflect all situations for a given surgical procedure and (3) that it was possible to define typologies of subjects with different morphologies, and to propose models per category or type of subject, which allowed learning under conditions much closer to real life.

Thus, the aim of the invention is to propose a training device that comes closer to the real-life handling experience than the devices of the prior art, and for surgical training, that takes into account the typology of the patients and the pathology.

### DESCRIPTION

The object of the invention is a training device for scientific or medical manipulation of a scientific or medical object, characterised in that the training device comprises an anatomically realistic 3D copy of the scientific or medical object, the 3D copy of the scientific or medical object comprising:
at least one anatomical part forming an inner layer of the 3D copy of the scientific or medical object, the at least one anatomical part having an outer surface and an inner surface, the at least one anatomical part being made of at least one first material that is capable of generating specific haptic feedback, and
an envelope forming an external layer of the 3D copy of the scientific or medical object, said envelope being made of at least a second material different from the first material, generating at least one haptic feedback different from that of the first material.

According to the invention, the envelope is able to cover all or part of the at least one anatomical part, the at least one anatomical part and the envelope being intended to cooperate structurally so that the envelope precisely matches the general shape of the outer surface of the anatomical part, so as to form an anatomically coherent structure.

Still according to the invention, the manufacture of the anatomical part and the envelope is carried out from at least one image of the scientific or medical object by additive manufacturing or 3D printing or by subtractive manufacturing or by moulding.

The present simulation thus makes it possible to realistically simulate, from an anatomical and/or haptic point of view, a scientific or medical intervention on a scientific or medical object with at least two layers of tissues/materials with different haptic properties, such as, for example, an organ covered with a bone envelope, or an organ covered with a skin envelope or a tissue covered with another tissue.

The wording “anatomical part” means a part that reproduces the two- or three-dimensional structure of a scientific or medical object, in particular, but not exclusively, an element of the human body, including an organ or a skeletal structure.

An anatomically coherent structure in the sense of the present invention means that the structure in question has realistic dimensions and shapes that are coherent with a biological anatomical model. It also means that the materials used allow a haptic feeling close to the haptic feeling of the biological anatomical model.

According to an embodiment, the scientific or medical manipulation of a scientific or medical object requires the presence and intervention of a user. According to an embodiment, the user is in particular a surgeon, a medical staff, a scientist, a technician.

In one embodiment, the scientific or medical object is a hazardous material or a rare material. A hazardous material may be, inter alia, a radioactive, flammable, explosive, corrosive, oxidising, asphyxiating or biologically hazardous material. A hazardous material may also be an allergenic, pathogenic or toxic substance or organism.

According to one embodiment, the scientific or medical object is all or part of an animal, a plant or a fungal species. According to an embodiment, the scientific or medical object is a human, a biological product, in particular a cell or a cellular tissue, or a chemical product or an industrial product, for example a machine. Thus, the scientific or medical object may be, in particular, all or part of a human or animal body, a cellular or tissue biological product, a chemical product or a manufactured industrial product. According to one embodiment, the scientific or medical object is a standard test subject, defined as the subject of an image selected because it is representative of a typology of patients and/or of a pathology and/or of a trauma. This scientific or medical object must enable to give rise to a three-dimensional copy, abbreviated 3D, based on an image thereof. According to an embodiment, the standard test subject is an adult between 16 and 75 years old. According to an embodiment, the standard test subject is an elderly person over 75 years of age. In one embodiment, the standard test subject is a child between 2 and 16 years old. In one embodiment, the standard test subject is a young child under two years of age. In one embodiment, the standard test subject is a young child less than six months old. In one embodiment, the standard test subject is male. In one embodiment, the standard test subject is female.

According to an embodiment, the scientific or medical object is a patient who is suffering from a pathology or who has suffered a trauma that requires a surgical or medical procedure.

According to an embodiment, the scientific or medical manipulation according to the invention is a surgical or medical act, a puncture, an injection, a suture, a study, an investigation, an analysis, a test or a step in a production process. According to an embodiment, the scientific or medical manipulation according to the invention is a minimally invasive surgical act. According to an embodiment, the scientific or medical manipulation according to the invention is a minimally invasive thoracic or visceral surgery procedure. According to an embodiment, the scientific or medical manipulation according to the invention is a neurosurgical procedure. According to an embodiment, the scientific or medical manipulation according to the invention is an orthopaedic procedure.

According to an embodiment, the scientific or medical manipulation according to the invention includes all surgical and orthopaedic procedures (regardless of the mode of operation and the type of material), and in particular:
Arthroplasties, in particular total coxo-femoral arthroplasty of first intention, partial knee arthroplasty
Surgical repair of recurrent shoulder dislocations,
Acromioplasty,
Osteosynthesis of an isolated or multiple fracture of a limb segment,
Surgical repair of a tendon wound in the forearm, excluding complex trauma,
Surgical repair of a tendon wound in the hand, excluding complex trauma,
Surgical release of ductal syndromes of the upper limb,
Surgical release in Dupuytren's disease,
Surgical repair of the calcaneal tendon (AN: Achilles tendon),
Surgical repair of the forefoot,
Osteotomies and/or transposition of the tibial tuberosity (AN: anterior tibial tuberosity),
Arthroscopy of the knee (meniscectomy, etc.), excluding ligamentoplasty,
Ligamentoplasty of the ankle,
Surgical tendon transposition (excluding central neurological pathology),
Spinal disc surgery, excluding disc prosthesis,
Spinal surgery with arthrodesis,
Spinal surgery for canal release without arthrodesis, orthopaedic procedures, including isolated or multiple fractures of a limb segment, or extra-articular fractures of the pelvis, treated orthopaedically; stable non-operated spinal fracture.

In one embodiment, the surgical procedure is a pre-operative procedure.

According to the invention, the anatomical part is manufactured, in additive or subtractive manufacturing, from a file created from medical imaging files, such as radiography, echography, scanner or magnetic resonance imaging or scintigraphy or echography or spectroscopic imaging, preferably having at least one 3D modality. In an embodiment, the image is obtained by X-ray technology, possibly after administration of radiopharmaceuticals to the subject. In an embodiment, the image is obtained by ultrasound technology. In an embodiment, the image is obtained by magnetic resonance. In an embodiment, the image is three dimensional. In an embodiment, the file for additive or subtractive manufacturing is created from one or more two dimensional images, processed to produce a three-dimensional part.

In one embodiment, the image is an anonymised image of all or part of a standard test subject, for example a body part of an animal, including a human, selected because it is representative of a patient typology and/or pathology and/or trauma.

In one embodiment, the image is an image of a particular subject, and the anatomical part and the envelope are customized reproductions of the physiology of that subject. The envelope and the anatomical part thus form a scientifically, and more particularly anatomically, coherent structure of the subject.

According to an embodiment of the invention, from the image of a scientific or medical object, or a subject or a standard test subject, an anatomical part and an envelope are produced. In one embodiment, the anatomical part and the envelope are identical in shape and size. In one embodiment, the dimensions of the anatomical part and/or the envelope are adapted to fit together. In an embodiment, the envelope and/or the anatomical part comprise means for attachment to each other or means for attachment to a base. According to an embodiment, the envelope and the anatomical part may be detached from each other and may be reattached to each other subsequently.

In one embodiment, the anatomical part is made of at least a first material chosen from among the thermoplastic polyurethane elastomers, known as TPU; in one embodiment, the TPU is chosen so that the anatomical part is representative of a soft organ, in particular of the type brain, liver, stomach, lung; in this embodiment, preferably the TPU has a Young's modulus between 0.006 and 20 GPa. In another embodiment, the TPU is chosen so that the anatomical part is representative of a hard tissue, such as in particular bone, cranial bone, spine, thorax; in this embodiment, preferably, the TPU has a Young's modulus between 0.024 GPa and 30 GPa. In one embodiment, the anatomical part comprises parts representative of organs or soft tissues, and parts representative of organs or hard tissues, made of different materials having suitable Young's moduli.

In one embodiment, the envelope is made of a rigid material. In an embodiment, the envelope is made of a deformable or elastic material. In one embodiment, the envelope is adapted to be superimposed on the anatomical part or to fit over the anatomical part. In another embodiment, the envelope is adapted to cover all or part of the anatomical part. In one embodiment, the second material that constitutes the envelope is a thermoplastic elastomer representative of human skin whose Young's modulus is preferably between 0.006 GPa and 20 GPa.

In an embodiment, the anatomical part and the envelope are manufactured using additive or subtractive manufacturing technology. In an embodiment, the anatomical part and/or the envelope are manufactured by moulding, wherein the mould is manufactured from the image of the scientific or medical object, in particular the standard test subject or the subject, by additive or subtractive manufacturing.

Thus, the anatomical part and the envelope reproduce the structure of a scientific or medical object, in particular of a standard test subject or a subject for training in order to enable one or more scientific or medical manipulations on this object, this standard test subject or this subject. The invention is therefore not a simple generic box, but a realistic physical representation of a scientific or medical object, in particular of a human or animal anatomical part.

In one embodiment, the file created for additive or subtractive manufacturing is modified prior to manufacturing, in particular to generate openings on the envelope and/or on the anatomical part. The advantage provided by the presence of opening(s) is in particular to allow the user to learn by palpation to choose the location of the trocars, and to learn with haptic feedback to insert the trocars into the orifices.

In one embodiment, an opening on the envelope can be used to simulate an incision in the skin of a standard test subject or a subject.

Depending on the nature of the scientific or medical manipulation, the shape and number of openings on said envelope may vary, and for example comprises:
(i) a single opening, for example for a non-minimally invasive surgical procedure, known as open surgery: this opening may be quite long and adapted to the nature of the said surgical procedure; this opening allows the insertion of an instrument or the simultaneous insertion of several instruments and also direct access to the anatomical part;
(ii) a plurality of openings, for example for a minimally invasive surgical procedure (MIS).

These openings may display a cylindrical shape, with a diameter smaller than that of the trocars used to perform the said surgical procedure, the diameter of a trocar being classically between 5 and 15 mm. These openings may, moreover, comprise at least two, three, preferably four incisions evenly distributed, for example in a star shape, around the periphery of the opening, which has the advantage of obtaining sufficient mechanical friction to hold the trocars in position; by plurality, we mean 2 to 50, preferably 2 to 30, more preferably 5 to 15 openings.

The diameter of an opening may be between 5 mm and 15 mm. The aperture may have an elasticity with a Young's modulus of preferably between 0.001 GPa and 0.1 GPa, and has the advantage of allowing an inserted trocar to remain in place, particularly when changing instruments. The aperture may allow a 360° pivotal connection of the trocar and positioning of said inserted trocar from a plane perpendicular to a plane parallel to the plane of the shell. The edge of the opening may be abrasion resistant during insertion and removal of the trocar or surgical tool or the user's finger.

According to an embodiment, when the training is done on a thorax, the openings are preferably placed between the ribs of the anatomical part of the standard test subject or of the subject; the number of openings may be between 10 and 30, preferably between 20 and 25; the openings are preferably positioned every 2 cm between two vertebrae, preferably on an axis of 120° C.; advantageously, the number of openings is between 10 and 12 per line.

According to an embodiment, the anatomical part allows to simulate a body part, a limb or an organ of a standard test subject or a subject. In this embodiment, the anatomical part is divided into two categories:
(i) the body anatomy, corresponding to the 3D printing of the part of the body of the standard test subject or of the subject concerned by the said surgical procedure, the body anatomy being able to be declined in a non-limitative way by:
   a thorax with ribs for a thoracic MIS procedure,
   an abdomen for a visceral MIS procedure,
   a head or skull for a neurosurgical procedure, or
   a knee or hip for an orthopaedic procedure.
(ii) organic anatomy, corresponding to the 3D printing of one or a plurality of organs of the standard test subject or subject concerned by the said surgical procedure. The organic anatomy may be non-restrictively declined by a spine, a liver, a stomach or a lung.

According to one embodiment, the anatomical part and/or the shell are manufactured in a non-limitative way by 3D printing or additive manufacturing or subtractive manufacturing.

As is well known, additive manufacturing consists of manufacturing parts in volume by adding or agglomerating material, by stacking successive layers using a 3D printer. Subtractive manufacturing, on the other hand, consists of subtracting material from a block or a raw part to achieve dimensional objectives using precision machines.

According to an embodiment, the anatomical part is manufactured in a non-limiting way by moulding, preferably with a silicone type material for example.

According to an embodiment, a 3D printing process used for the manufacture of the anatomical part is non-limitingly of the type:
FDM—fused deposition of wire,
selective laser melting of powder, known as SLM,
selective laser sintering of powder, known as SLS,
Binder Jetting of a powder,
Electron beam melting of powder (EBM),
SLA powder photopolymerisation,
SLA liquid stereolithography,
LOM solid laminate object modelling, or
Digital Light Processing (DLP).

According to an ambodiment, the material used for the manufacture of the anatomical part is non-limitingly from the family of thermoplastic elastomers known as TPE, of the type:
Polyurethane TPE called TPE-U or TPU,
TPE styrenic called TPE-S or TPS,
thermoplastic copolyamide called TPE-A or TPA, or
ether-amide block copolymer known as PEBA.

According to an embodiment, the material used to manufacture the anatomical part is non-limitingly from the family of elastomeric resins, silicones, neoprene and other synthetic rubbers.

In one embodiment, the anatomical part is made of a material having physical touch characteristics that reproduce the touch of a real (real in the sense of biological) anatomical part of a scientific or medical object and that enables the user's exteroceptive sense of touch or haptic sense to be stimulated.

The haptic sense allows to differentiate in particular:
the texture felt by friction and displacement,
the hardness, felt by pressure,
the temperature, felt by fixed and static contact,
the weight felt by lifting and weighing,
the shape felt by envelopment,
the overall shape felt by contour tracking.

In one embodiment, the anatomical part is made of a material having physical colour characteristics that reproduce the colour of a real anatomical part of the scientific or medical object.

According to one embodiment, the anatomical part comprises a plurality of organs arranged together in a similar way as in a real situation. According to an embodiment, the anatomical part reproduces one or more organs, which in a real situation (i.e., in a biological situation) would have been placed under the envelope. As already mentioned, the envelope is intended to precisely match the general shape of the outer surface of the anatomical part, so as to form an anatomically coherent structure. The envelope may be in direct contact with the anatomical part. In another embodiment, there may be a gap between the shell and the anatomical part.

According to an embodiment, the envelope allows to simulate the skin of a standard test subject or a subject, covering one or more organs or anatomical structures, such as bones. Depending on the nature of said surgical procedure, said envelope is suitable and intended to cover all or part of the body anatomy. According to another embodiment, the envelope allows, for example, to simulate a bone cavity covering one or more organs. According to another embodiment, the envelope allows to simulate the outer layer of a tissue, organ or any anatomical structure, the covered anatomical object allowing to simulate an inner layer or interior of the tissue, organ or anatomical structure. For example, the cover may simulate the epidermis and the anatomical object may simulate the dermis and hypodermis.

According to an embodiment, the envelope is manufactured in a non-limitative way from a material of the family of thermoplastic elastomers, called TPE, of the type:
Polyurethane TPE, known as TPE-U or TPU,
TPE styrenic called TPE-S or TPS,
thermoplastic copolyamide called TPE-A or TPA, or
ether-amide block copolymer known as PEBA.

According to one embodiment, the envelope is made non-limitingly of a material from the family of elastomeric resins, silicones, neoprene and other synthetic rubbers.

The advantage of this type of material is that the envelope offers resistance and does not collapse under the manual pressure of the user, pressure exerted in a direct way (pressure of handles or forearms for open surgery) or indirectly (pressure of trocars and instruments for minimally invasive surgery).

In one embodiment, the envelope is manufactured non-limitingly by means of a moulding by taking an impression of the body anatomy of the standard test subject or subject, which will then serve as a mould in which a material is placed to allow a single print or the production of several copies of the envelope. The print consists of placing a material (liquid, paste, powder, sheet, plate, tablet, etc.) in the mould, which the material will take the shape of.

According to an embodiment, the choice of materials constituting the anatomical part and the envelope is important in order to offer a sensory rendering as close as possible to that expected during the actual surgical procedure, both in terms of sensation when touched with the hands, and in terms of the resistance and flexibility of the anatomical parts when trocars are introduced or surgical instruments are used.

In particular, the envelope, independently of the covered anatomical part, must allow the user to feel haptic feedback close to biological reality. The anatomical part must also, independently of the envelope, allow the user to experience haptic feedback close to biological reality. The combination of the anatomical part and the envelope thus allows for optimised haptic feedback, making it possible to offer a user a true and precise reproduction of the haptic and steric sensations felt during a scientific or medical manipulation, in particular a surgical one, on the scientific or medical object represented.

According to an embodiment, the envelope is such that it generates at least two haptic sensory feedbacks of different nature. These two haptic sensory feedbacks of different nature are generated in contact with at least two materials arranged and offering a different reactivity of one compared to the other.

In one embodiment, the difference in at least two haptic sense returns is due to the different characteristics of the materials used to manufacture the anatomical parts.

The envelope is thus such that it generates a continuous haptic experience corresponding to the entire surgical procedure, from the first insertion of a surgical tool to the last step of the operation.

This continuous haptic experience is due to the manufacture of anatomical parts based on the image of the standard test subject or subject.

In one embodiment, the device further comprises a base to which the anatomical part and the envelope are independently attached, the envelope covering all or part of the anatomical part.

In one embodiment, the training device consists of an interlocking envelope covering all of the anatomical parts and attached to a base.

The training device according to the invention can be used for training surgical procedures or scientific or technical procedures in the scientific, medical, veterinary, nuclear, chemical, pharmaceutical, biological and industrial fields.

According to the present invention, the anatomically realistic 3D copy of the scientific or medical object does not need to be transparent. Indeed, in the context of the present invention, the training device can be used in combination with virtual reality software, itself operating in combination with the training device and a display device for this virtual reality: the training device allowing haptic feedback and the software allowing visual and/or sound feedback. According to this embodiment, the training device is intended to communicate with the virtual reality software and the display device. Thus, when using the training device, the user interacts with the shell and/or the anatomical part, for example by manipulating a surgical tool, and visualises said interaction by means of the software and a display device. The display device may for example be a virtual reality headset, adjustable to the user and capable of providing audio feedback. The display device acts as a link between the training device and the virtual reality software.

### BRIEF DESCRIPTION OF THE FIGURES

The invention will be better understood from the following description, which is given by way of example and is by no means limiting, with reference to the following figures:

FIG. 1 is a photograph showing the training device mounted on a support.

FIG. 2a is a photograph showing an example of anatomical organs, in this case a spine and part of a thorax, mounted on a support.

FIG. 2b is a photograph showing an example of an anatomical organ, in this case part of a thorax.

FIG. 3a is a perspective photograph showing an example of an envelope with a plurality of openings for a minimally invasive surgery (MIS) procedure on a portion of a half thorax in a sagittal section plane.

FIG. 3b is a photograph in a different perspective compared to FIG. 3a, illustrating an example of an envelope with a plurality of openings for a minimally invasive surgery (MIS) procedure on a half-thorax portion in a sagittal section plane.

FIG. 3c is a bottom view photograph illustrating an example of an envelope with a plurality of openings for a minimally invasive surgery (MIS) procedure on a half-thorax portion in a sagittal section plane.

In these figures, identical references from one figure to another designate identical or similar elements. For reasons of clarity, the features shown are not to scale unless otherwise noted.

### DESCRIPTION OF THE FIGURES

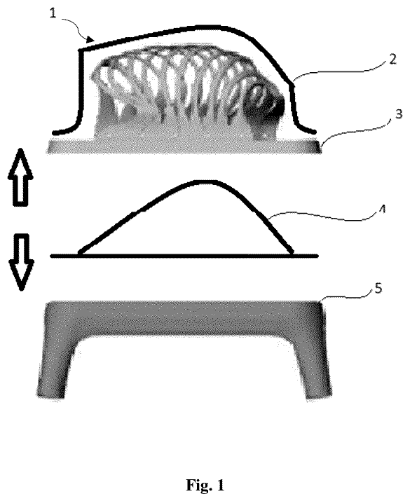

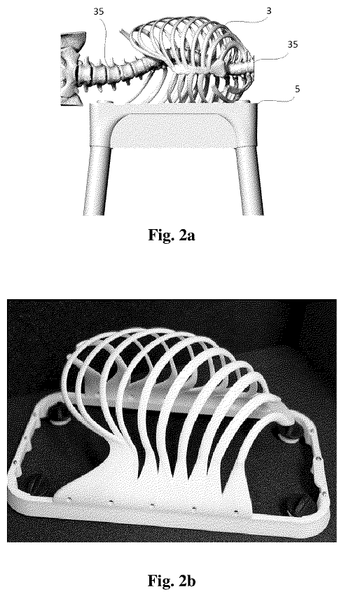

In an embodiment illustrated in FIG. 1, in a sagittal cross-sectional plane, the training device 1 corresponds to a half thorax of a subject. The training device 1 consists of an interlocking envelope 2 covering the whole of the anatomical parts 3 and 4, the whole being attached to a base 5. Fastening means allows the user to insert and remove the components of the training device 1 by hand without the use of special tools. In an embodiment illustrated in FIG. 2a, in a cross-sectional plane, two anatomical pieces corresponding to a spine 35 nested inside a thorax 3, are attached to the base 5. In this embodiment, the envelope 2 (not shown) is fitted over the two anatomical parts.

In an embodiment illustrated in FIG. 2b, in a sagittal cross-sectional plane, an anatomical part 3, 4 corresponding to a profile of a half thorax is shown. The choice of the material constituting an anatomical part 3, 4 is variable and can be achieved by an additive manufacturing process (3D printing) of powder bed technology (type SLS or MJF), wire deposition (FDM) or resin light curing (type SLA or DLP). In the case of simulating body parts with an elasticity of Young's modulus between 0.006 GPa and 20 GPa, for example in the case of an anatomical abdominal part, the structure of this anatomical part can be made by 3D printing in an elastomeric thermoplastic (TPE) material such as PEBA, PEBAX or TPU, or an elastomeric resin such as silicones, neoprene and other synthetic rubbers.

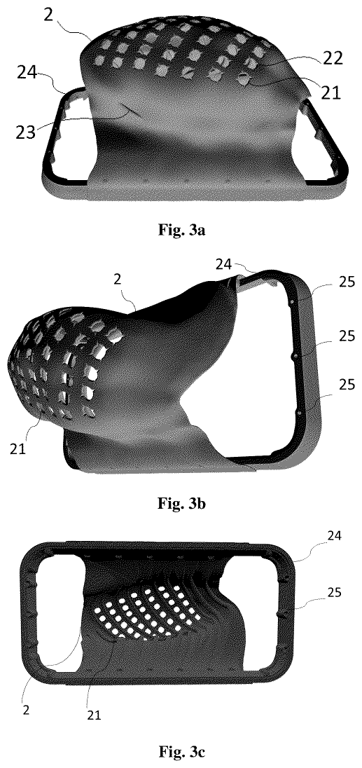

In the embodiment illustrated in FIG. 3a, an envelope 2 corresponding to a profile of a half-thorax in a sagittal section plane, supporting a single opening 23, for example for a non-minimally invasive surgical procedure, known as open surgery: this opening 23 may be quite long and adapted to the nature of said surgical procedure, this opening 23 allows the insertion of an instrument or the simultaneous insertion of several instruments and also direct access to the anatomical part, a plurality of openings 21, intended for training in a minimally invasive surgical procedure (MIS). These openings 21 may display a cylindrical shape, with a diameter smaller than that of the trocars used for surgery, whose usual diameter is between 5 and 15 mm, and may comprise at least two, three, preferably four incisions 22 distributed uniformly, for example in a star shape, around the periphery of the openings. The choice of material constituting the envelope 2 is variable and may be chosen from among: thermoplastic polyurethanes (TPU) or neoprene of 3 mm thickness. The colour panel of the material constituting the envelope 2 is variable, it is of a matt tone, it is adapted either to a colour adapted to the handling or to the scientific or medical object, or to a colour which does not disturb the functioning of a space localization device by camera. The envelope 2 consists at its base of a rectangular frame 24 intended to support the envelope 2.

In an embodiment illustrated in FIG. 3b, in a different perspective compared to FIG. 3a, an envelope 2 is shown corresponding to a profile of a half thorax in a sagittal section plane, where the openings 21 are cylindrical in shape and smaller in diameter than the trocars. The envelope 2 consists at its base of a rectangular frame 24 for supporting the envelope 2. The frame 24 comprises a plurality of fastening means 25 distributed over the short sides of the frame 24 for fastening the envelope 2 to the base 5, here the base 5 is not shown.

In an embodiment illustrated in FIG. 3c, in a bottom view, an envelope 2 is shown corresponding to a profile of a half thorax in a sagittal section plane, supporting a plurality of openings 21 in the case of a minimally invasive surgical procedure (MIS). The number of openings is between 20 and 25, the openings are positioned between the ribs every 2 cm between two vertebrae on an axis of 120° C., the number of openings per line is between 10 and 12.

In an embodiment illustrated in FIG. 3c, the envelope 2 is formed at its base by a rectangular frame 24. The frame 24 comprises a plurality of fastening means 25 distributed over the short sides of the frame 24 for securing the envelope 2 to the base 5, here the base 5 is not shown.

The present invention can find applications in all fields, and has uses in the scientific, medical, veterinary, nuclear, chemical, pharmaceutical, biological and industrial fields.

The present invention thus makes it possible to reproduce, in a realistic manner, the technical complexity of a medical and/or scientific environment, in particular an anatomical environment, during a medical and/or scientific operation, in particular a surgical operation. It allows a faithful reproduction of the sensations perceived during this operation and thus, to think about a spatial strategy to carry it out in an efficient, reliable and secure way.

1.-14. (canceled)

15. A training device for scientific or medical manipulation of a scientific or medical object, wherein the training device comprises an anatomically realistic 3D copy of the scientific or medical object, the 3D copy of the scientific or medical object comprising:
at least one anatomical part forming an inner layer of the 3D copy of the scientific or medical object, the at least one anatomical part having an outer surface and an inner surface, the at least one anatomical part being made of at least one first material that is capable of generating specific haptic feedback, and
an envelope forming an external layer of the 3D copy of the scientific or medical object, said envelope being made of at least a second material different from the first material, generating at least one haptic feedback different from that of the first material, the envelope being able to cover all or part of the at least one anatomical part, the at least one anatomical part and the envelope being intended to cooperate structurally so that the envelope precisely matches the general shape of the outer surface of the anatomical part, so as to form an anatomically coherent structure, the manufacture of the anatomical part and the envelope being carried out from at least one image of the scientific or medical object by additive manufacturing or 3D printing or by subtractive manufacturing or by moulding.

16. The training device according to claim 15, wherein the scientific or medical object is all or part of a human or animal body, a cellular or tissue biological product, a chemical product or an industrial manufactured product.

17. The training device according to claim 15, wherein the anatomical part and the envelope are detachable from each other.

18. The training device according to claim 15, wherein the envelope generates at least two haptic sense feedbacks of different nature.

19. The training device according to claim 15, wherein a first material is a thermoplastic polyurethane elastomer, known as TPU, representative of a hard organ, in particular a bone, cranial bone, spine or thorax, and/or a thermoplastic polyurethane elastomer, known as TPU, representative of a soft organ, in particular a brain, liver, stomach or lung.

20. The training device according to claim 15, wherein the second material is a thermoplastic elastomer representative of human skin having a Young's modulus between 0.006 GPa and 20 GPa.

21. The training device according to claim 15, wherein the envelope comprises a single aperture or a plurality of apertures of diameter less than 15 mm, and comprises at least two, three or four incisions evenly distributed around the periphery of the aperture.

22. The training device according to claim 15, wherein the envelope is superimposed on the anatomical part or fits over the anatomical part.

23. The training device according to claim 15, wherein it further comprises a base to which the anatomical part and the envelope are independently fixed, the envelope covering all or part of the anatomical part.

24. The training device according to claim 23, wherein the anatomically coherent structure comprises means for attachment to the base.

25. The training device according to claim 15, wherein the anatomically coherent structure comprises means of attachment between the envelope and the anatomical part.

26. The training device according to claim 15, wherein the training device is intended to communicate with virtual reality software and a display device for such virtual reality.

27. A method for training surgical acts or scientific or technical acts in the scientific, medical, veterinary, nuclear, chemical, pharmaceutical, biological, industrial field, comprising operating the training device of claim 15.

28. A method of training for scientific or medical manipulation of a scientific or medical object, comprising operating the training device according to claim 15 in combination with virtual reality software and a display device for such virtual reality.
